(19) United States
(12) Patent Application Publication
(10) Pub. No.: US 2014/0095303 A1
(43) Pub. Date: Apr. 3, 2014

(54) Apparatus and Method for Personalizing Maps

(71) Applicant: Google Inc., Mountain View, CA (US)

(72) Inventors: Jonah Jones, Darlinghurst (AU); Bernhard Seefeld, New York, NY (US); Patrick Hofmann, Sydney (AU); Zhou Bailiang, Balgowlah (AU); Willem Van Lancker, San Francisco, CA (US); Amanda Marie Leicht, San Francisco, CA (US); Taj Jay Campbell, San Francisco, CA (US)

(21) Appl. No.: 13/632,938

(22) Filed: Oct. 1, 2012

(51) Int. Cl. G06F 17/30

(52) U.S. Cl. CPC G06F 17/30241
USPC 705/14.49; 707/748; 707/751; 707/706

(57) ABSTRACT

Provided is a process for personalizing an interactive map that includes the following: receiving a user request to view an interactive map; determining a map extent responsive to the request; obtaining a profile of the user; personalizing, with a computer, an interactive map based on the profile; and presenting the personalized map to the user. Personalizing includes determining whether to depict geographic features within the map extent in the personalized map based on the profile, and formatting a depiction of the features to have, for each respective feature, a prominence determined based on the profile.

### BACKGROUND

1. Field of the Invention

The present invention relates generally to interactive maps and, more specifically, to personalizing interactive maps.

2. Description of the Related Art

Interactive maps are often used to obtain information about geographically distributed features, such as roads, cities, states, businesses, rivers, lakes, and the like. The interactive map is viewed on a user device, such as in a web browser or mapping application of a laptop or smart phone, and the viewed information is provided by a remote server over the Internet. Typically, users interact with the map by commanding (e.g., by touching or clicking on the interface) the map to pan, zoom, or otherwise change the geographic extent depicted in the map viewport, and the remote server provides information responsive to these interactions. Further, users often enter search terms to cause the interactive map to depict a responsive geographic extent or request a map depicting the user's current location as determined by, for example, a GPS device in a smartphone.

### SUMMARY OF THE INVENTION

The following is a non-exhaustive listing of some aspects of the present techniques. These and other aspects are described in the following disclosure.

Some aspects include a process for personalizing an interactive map that includes the following: receiving a user request to view an interactive map; determining a map extent responsive to the request; obtaining a profile of the user; generating, with a computer, a personalized interactive map based on the profile; and presenting the personalized map to the user. Generating the personalized map based on the profile may include obtaining candidate features within a geographic extent specified by the user request from a geographic information system, the candidate features having a prominence ranking determined without regard to the user profile before receiving the user request; adjusting the prominence ranking of some of the candidate features based on the user profile; for each candidate feature, using the adjusted prominence ranking to determine whether to depict the respective candidate feature; and for each depicted feature, using the adjusted prominence ranking to format the corresponding depiction.

Some aspects include a system having one or more processors and memory storing program code that when executed by the one or more processors causes the one or more processors to perform the above-described process.

Some aspects include a tangible, machine-readable medium storing instructions that when executed by a data processing apparatus causes the data processes apparatus to perform the above-described process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates an example of an interactive map system in accordance with some embodiments;

FIG. 2 illustrates a process for personalizing an interactive map in accordance with some embodiments;

FIGS. 3 and 4 illustrate interactive maps of identical map extents personalized for two different users in accordance with some embodiments;

FIG. 5 illustrates an example of a computer system by which various portions of the above described system and processes may be implemented.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF CERTAIN EMBODIMENTS

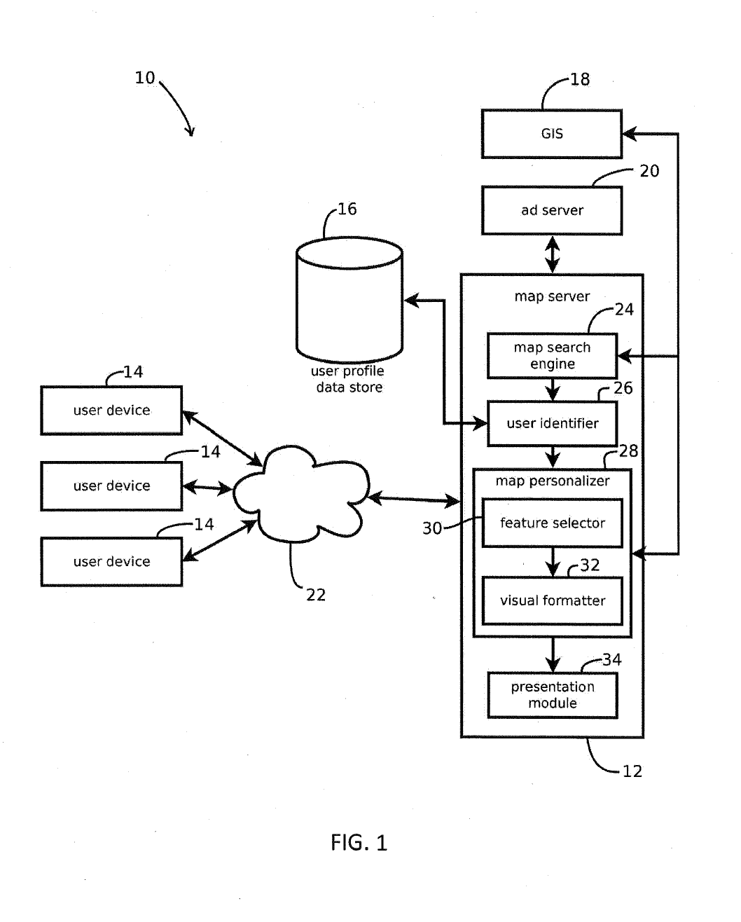

FIG. 1 illustrates an embodiment of an interactive map system 10 having a map server 12 capable of personalizing interactive maps on user devices 14 based on corresponding user profiles in a user profile data store 16. The maps are personalized in order to account for a limited user appetite for, and capacity to process presented information, so the map does not overwhelm the user with excessive information of little interest or obscure information in which the user is likely to be interested. The map server 12 has access to substantially more information about a geographic area depicted in an interactive map (i.e., a map extent) than is of interest to a user, so the map server 12 determines which information is presented and how prominently that information is presented within the interactive map. Embodiments make these determinations on a person by person basis, using corresponding user profiles stored in the data store 16. Thus, different users with different profiles are presented with different information and differently visually formatted information even when viewing an identical map extent at the same time.

Maps are personalized in a variety of different ways by modifying a variety of different aspects of the map, but a specific example is illustrative. A given user profile may indicate a preference for Indian cuisine (e.g., due to the user rating restaurants in this category above a threshold rating), that the user resides in the United States (e.g., as indicated by an average location of the user's location history), and that the user has recently searched for hotels in London (e.g., according a search history in the user profile). Given this profile, in response to a query from the user for “London England,” some embodiments of the map server 12 present the user with an interactive map of London England with Indian restaurants and sites of interest to tourists displayed and visually formatted relatively prominently, for example with a font size and color selected for emphasis, while a user submitting the same query but without a profile would not be presented with this information in this format. A different user profile may indicate that a user resides in London and has recently searched for dog parks. An interactive map of the same extent but for the second user, in some embodiments does not depict the Indian restaurants or sites of interest to tourists, but does depict features likely to be of interest to a resident of the city who has a dog, such as a pet grooming business near (e.g., within a threshold distance of) the user's residence and a recently opened (e.g., within a threshold time) restaurant near a bar that the user frequently checks into, according to the second user's profile. Again, the information that is presented, and the visual weight, or prominence, depends on the profile of the user who requested information. In these two examples, identical requests for interactive maps yield information selected and visually formatted to direct the user's attention to features that are likely to be relevant to the individual user (but not necessarily to users in general) and avoid cluttering the map with information that is likely to be a little interest to the user, as indicated by the user's profile.

In some embodiments, the map server 12 obtains information to be presented from a geographic information system 18 and an advertisement server 20. The geographic information (GIS) 18 is operative to identify features within a map extent based on stored associations between feature names and their geographic location and stored relationships between features, e.g., which features, such as a business, are within an area of another feature, such as a city. In some embodiments, the identified features are each associated with an age of the feature, indicating when the feature was added to the GIS 18, a value which is used identify newer features likely to be of interest to residents of an area. The map server 12 requests features from the GIS 18 and determines which features are presented in a map and how those features are formatted visually in the presentation.

In some embodiments, the features stored in the GIS 18 are assigned a default rank that, in maps that are not personalized according to user profiles, affects (e.g., is the sole determinant or is one factor among others) which features are presented and the visual formatting of those features. For example, interstate highways in the United States have a relatively low rank (multiple features within a map may have the same rank, such as multiple interstate highways), and smaller roads, such as a neighborhood road ending in a cul-de-sac, have a relatively high default rank. Consequently, absent personalization of the map, at a given zoom level, the lower ranking interstate highway may be presented, while the higher ranking smaller roads is omitted from the map to avoid clutter, except at relatively detailed zoom levels, i.e., at relatively small map extents.

Further, in some embodiments, the advertisement server 20 is operative to provide advertisements to be presented with the interactive map based on, e.g., the map extent, the request that caused the map to be presented, or the corresponding user's profile, in response to a request from the map server 12 or a user device 14. After presenting an ad, the entity operating the map server 12 is compensated by an advertiser.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by the system 10.

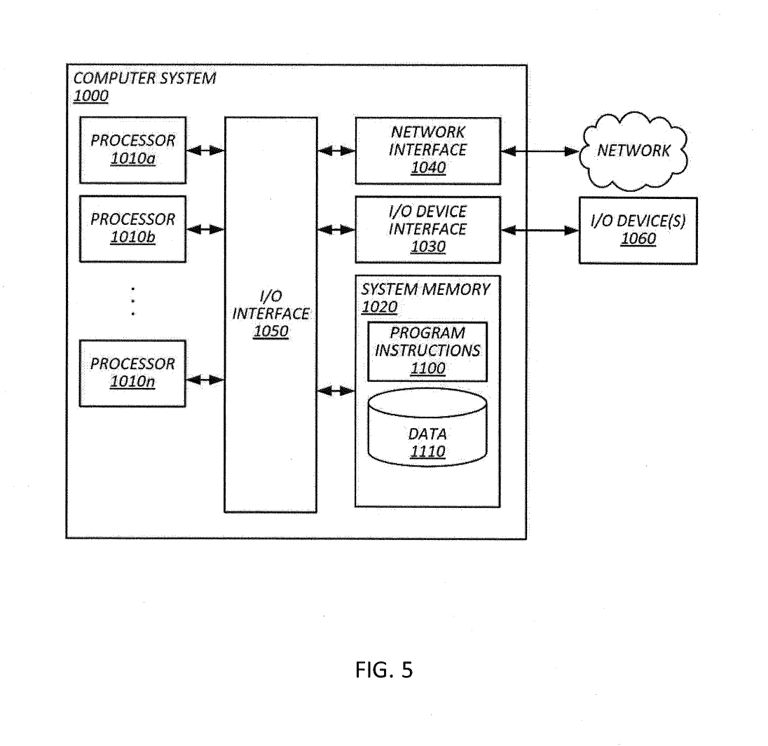

The illustrated system 10 includes three user devices 14, but embodiments are consistent with substantially more user devices. These devices may be any of a variety of different computing devices, examples of which are described below with reference to FIG. 5. The user devices 14 include an operating system and may include a browser in which the interactive map is rendered for a user and through which the user interacts with the interactive map by, for example, requesting that the map be zoomed in or out, panned, or that a map corresponding to a map search query be presented. In another example, a special-purpose mapping application executes on the user devices, displays the map to the user, and receives user commands. User devices 14 communicate with the map server 12 in sessions, which begin when a user initially requests an interactive map and end when the user navigates away from the map server. User requests during such a session are not considered part of the user profile for purposes of personalizing the map (e.g., a map is not personalized merely because the map is responsive to a single user query in the current session), though such requests are logged in the user profile and used to personalize the map during subsequent sessions.

Provided that data acquisition and use is consistent with user privacy controls, the user profile contains both data from previous sessions of the user with the interactive map and data from user interactions with other services than those provided by the map server 12. Other services include web-based or special-purposes applications in which a user device 14 communicates with a remote server and by which users review places or rate places, interact with social networks, record places and web resources of interest to the user (e.g., bookmarked places or websites), check in to places on location-based social networks. In other examples, the user profile contains a user's search history from user queries submitted to a universal search engine that is responsive to topics other than those relating to maps and user selections of search results. The profile may also include user preferences (e.g., types of events, cuisine, or activities in which the user is interested) and attributes (e.g., the location of user's residence or work) provided by the user to facilitate better personalization of maps. The data store 16 stores a plurality of user profiles, and each profile is associated with (e.g. uniquely matched to) a user device, a user account, or other value by which users are distinguished from one another by the map server 12.

The map server 12 communicates with user devices 14, the user profile data store 16, the GIS 18, and the advertisement server 20 via, for example, the Internet 22 or various networks, such as local-area networks, wireless area networks, and cellular networks. The map server 12 of this embodiment includes a map search engine 24, a user identifier module 26, a map personalizer 28, and a presentation module 34. These components, and the other components of the system 10, are illustrated as discrete functional blocks, but program code and hardware by which the functional blocks are implemented may be conjoined, distributed, subdivided, intermingled, or otherwise differently organized relative to the arrangement of FIG. 1. Program code by which the functionality described herein is implemented may be stored on a tangible non-transitory machine-readable medium, and when this program code is executed by a data processing apparatus, such as one or more computer systems, that data processing apparatus performs the operations described herein.

The map search engine 24 of this embodiment is operative to receive a user query for an interactive map, such as a query expressed in text by the user and naming a place, and determine a map extent that is responsive to that query. The map search engine 24 cooperates with the GIS 18 to identify terms within the query corresponding to geographic locations and a map extent corresponding to the query. For instance, a query for “Austin, Tex.,” or a query for “capital of Texas” received by the map search engine 24 causes the map search engine 24 to determine a map extent corresponding to Austin Tex., a place for which the location (including bounding area) and names are associated by the GIS 18.

The user identifier module 26 is operative to determine whether a user profile is associated with the received query and, if so, identify (e.g., uniquely identify among the stored user profiles) the corresponding user profile. For example, the user identifier 26 determines whether the user is logged in to the map server 12 or whether another identifier associated with the request, for instance an Internet protocol address, is associated with a user profile. The user identifier module 26 further determines whether user specified privacy controls indicate a user preference for using the user profile information in the manner described here and, in response, selectively permits the use of user profile information in accordance with the privacy controls.

The map personalizer 28 of this embodiment is operative to receive the user profile, the map extent, and features within the identified map extent and personalize an interactive map. To this end, the map personalizer 28 determines, based on the user profile, which features within the map extent will be presented and a visual weight, or prominence, of those features by selecting visual formatting attributes, such as fonts, line weight, drop shadows, font color, font size, and the like, among a plurality of candidate settings for such visual attributes. In some embodiments, the map personalizer 28 performs this determination in real-time (e.g. within less than one second of receiving the user's request for interactive map).

As noted above, the features received from the GIS 18 are each associated with a default rank. Some embodiments of the map personalizer 28 adjust this default rank based on the user profile if a profile is available. Features likely to be relevant to the user, as inferred from the user profile, are adjusted by decreasing the rank of those features, making the features more prominent and more likely to be depicted at a given zoom level. Conversely, features likely to be of little relevance to the user, as inferred from the user profile, are adjusted by increasing their rank. For example, a flyfishing equipment store may have a relatively high default rank, making it unlikely that that flyfishing equipment store would appear in a map of the state of California, i.e., at a relatively low granularity zoom level, but a user profile indicating a strong interest in flyfishing (e.g., one having more than a threshold amount of queries including the term “flyfishing” in the user's search history) may cause the rank of that flyfishing equipment store to be decreased to the point at which the store appears in a map depicting the entire state of California.

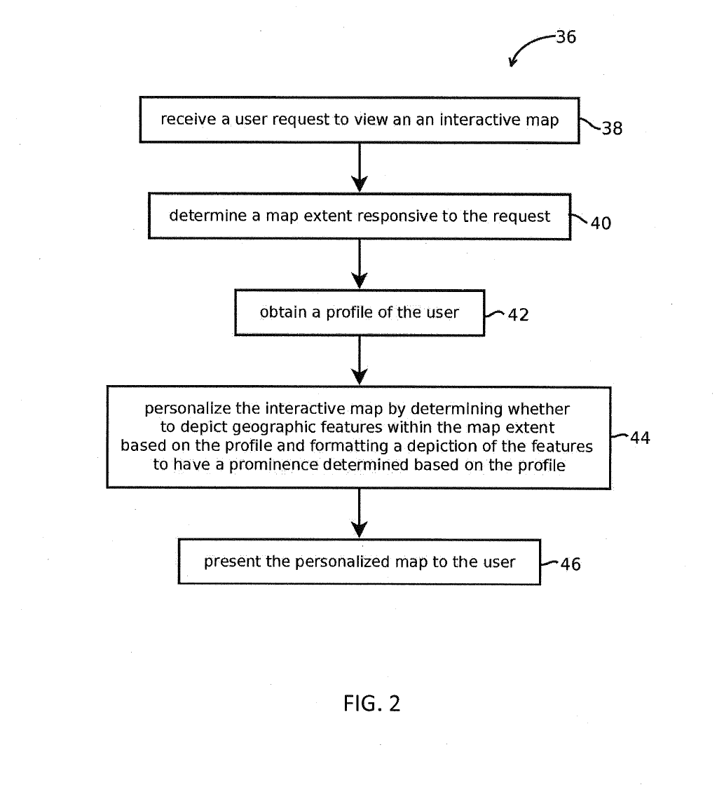

In some embodiments, the map personalizer 28 includes a feature selector 30 and a visual formatter 32. The feature selector 30 is operative to determine which features are presented in the interactive map among the set of features within the map extent. In an example, the feature selector 30 receives a map extent, a plurality of candidate geographic features within that map extent, and the user profile. Based on the user profile, some of the candidate geographic features are added to a result set of geographic features to be presented in the interactive map and some of the candidate geographic features are omitted from the result set of features to be presented. Examples of this determination are described in greater detail below with reference to FIG. 2. The illustrated visual formatter 32 is operative to determine a visual format with which the geographic features are presented in the interactive map based on the user profile. In some embodiments, the visual formatter 32 selects a visual format—such as a font size, a font color, a drop shadow, a line weight, a feature color, a transparency, a feature size, a three dimensional feature presentation, or other format attributes, including various sub combinations of the listed attributes. The visual format is selected from among a plurality of candidate combinations of format attributes (e.g., from among candidate styles each defining a group of visual formatting options applied together). And the selection of a visual format is based on the inferred relevance of the corresponding feature derived from the user profile, e.g., based on an adjusted rank corresponding to a candidate style. Examples of this selection are described in greater detail below with reference to FIG. 2.

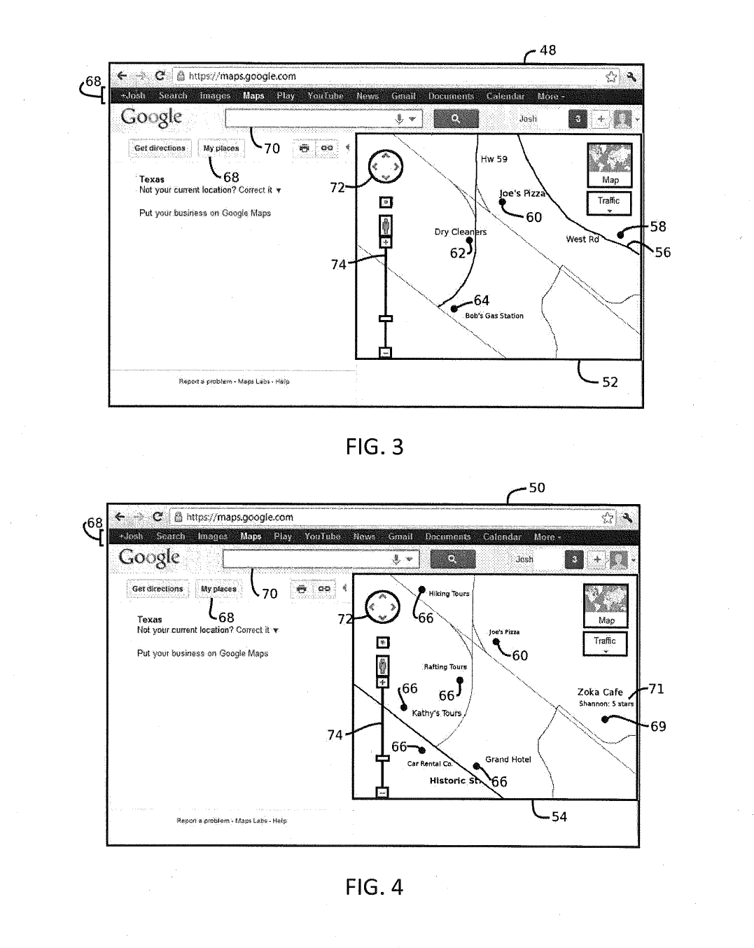

The presentation module 34 is operative to receive the selected features and visual formatting from the map personalizer 28 and, in response, present a responsive interactive map to the corresponding user device 14 from which the request was received. In some embodiments, the presentation module 34 renders images depicting the selected features (and omitting the unselected features) with the selected visual formatting and transmits the rendered images (which may be rendered in real-time) to the corresponding user device 14 along with instructions to display the images within the interactive map. Examples of the interactive map are described in greater detail below with reference to FIGS. 3 and 4.

FIG. 2 illustrates an embodiment of a process 36 for personalizing an interactive map based on a user profile. The process 36 is performed by embodiments of the map server 12 described above with reference to FIG. 1. In some implementations, program code that, when executed by a data processing apparatus, causes the data processing apparatus to perform the process 36, is stored on a tangible non-transitory machine-readable medium.

In this embodiment, the process 36 includes receiving a user request to view an interactive map, as shown by block 38, and determining a map extent responsive to the request, as shown by block 40. In some cases, determining a map extent includes parsing a text query, querying the GIS 18 for geographic features corresponding to the parsed query terms, and identifying the location of those geographic features in a response from the GIS 18. In some embodiments, the map extent is determined in the received user requests, for example in a request to show the user's current location and a predefined amount of surrounding area. The map extent may be expressed in a variety of formats, for example as a center point and a zoom level or as latitudes and longitudes of the vertices of a bounding box.

The process 36 further includes obtaining a profile of the user from whom the request was received, as indicated by block 42. The profile is obtained from the user profile data store 16, which in some embodiments, includes a plurality of different data stores, each data store corresponding to a different service with which the user interacts over the Internet. Examples of data in the profile include places that the user has labeled on the interactive map in previous sessions, places that the user has rated, places that the user has identified as their home or their work, places for which the user has searched, places the user has identified in search results (e.g., by clicking on a link corresponding to the place), places that the user has saved in user-created maps, places identified in a location history of the user's device, events that the user has indicated to be of interest, categories of features that the user has indicated to be of interest, or user check-ins on location-based social networks. Further examples include any of the preceding sources of data from an adjacent node to the user in a social network, provided that the use and provision of such data is consistent with privacy controls of the other user.

The user profile includes data from a plurality of different services with which the user interacts over the Internet, such as a map search engine, a universal search engine responsive to topics other than those relating to location, a social network that documents connections between users (e.g. friends, family, coworkers, or shared interests), a location-based social network that documents check-in's to locations, user account data documenting user-provided information including the user's address and preferences (e.g. cuisine preferences, event preferences, and place preferences), and services by which the user can map their location history and document places that have been of interest to the user (e.g., by recording a unique identifier of the place that distinguishes the place from other places and some attribute assigned by the user to the place, such as a favorite designation).

The process 36 further includes personalizing the interactive map by determining whether to depict geographic features within the map extent based on the profile and formatting a depiction of the features to have a prominence determined based on the profile, as indicated by block 44. As described above, some embodiments perform this step by first receiving a set of candidate features from the GIS 18 along with a default ranking of those candidates features, where the ranking determines whether a feature is depicted at a given zoom level and the prominence arising from the visual formatting of the feature. The default rankings of the candidate features are then adjusted based on the user profile. The adjusted rank is then used to determine whether a feature is shown, with lower ranking features given priority over higher ranking features. The rank is further used to determine the appearance of a feature, with ranked features being given a higher prominence.

The rank may be adjusted based on a variety of signals. In one example, a user's familiarity with an area is inferred with a familiarity score based on previous interactions with the interactive map. The area that a user views in the interactive map during each session is logged, and views of an area are summed or otherwise aggregated over a preceding duration, such as over the preceding six months, to determine the familiarity score. Areas the user has viewed relatively frequently are likely areas with which the user is familiar. In response, relatively old places, such as major road near the user's residence, are raised in rank. In some embodiments, the default rank of a feature is obtained with a feature age, indicating when the feature was added to the geographic information system, and the default rank is adjusted based on the feature age and the familiarity score such that newer features are lowered in rank and higher familiarity scores increase the effect of feature age. For example a new restaurant near the home of a user may be more likely to be displayed than a historic building having a lower default rank.

In another example, categories of places in which the user is likely to be interested are determined based on the user profile, and the default rank is adjusted when a place category matches one of the categories. In some embodiments, the user profile includes user entered preferences for categories, such as restaurants of a particular cuisine, types of clothing stores, types of hobbies, and the like. Or preferences for categories are inferred from other data in the user profile, for example from the user rankings of restaurants or other places.

In another example, profiles of friends of the user are used to adjust the default feature rank. The user profile includes identifiers of adjacent nodes to the user in a social network graph, and those adjacent nodes are each associated with a user profile of a different corresponding user, e.g., friends of the user who submitted the request for a map. The process 36, in some embodiments, includes obtaining the profiles of the adjacent nodes and adjusting rank based on the data in those profiles. For example, the default rank of a particular place may be decreased in response to a friend of the user giving the particular place a favorable review, the friend's review being logged in the friend's user profile. As noted above, users are given control over both the collection and use of personal information. Thus, users can control whether their personal information is used in the manner described.

In another example, calendar entries in the user profile are used to adjust the default rank. For instance, a scheduled appointment at a particular address within a threshold duration of time in the future causes the rank of the feature associated with that address to be decreased, making the feature more likely to appear and to appear prominently. For example, a calendared doctor's appointment for later in the day when the request for a map was received causes the doctor's office to be lowered in rank.

In some embodiments, the process 36 includes inferring based on context what a user intends to do in an area being depicted. For example, an intent to engage in tourism may be inferred by determining that a location of the user is more than a threshold distance from the map extent requested. In response, the rank of features associated with tourism in the GIS 18 is decreased, such that points of interest to a tourist are more likely to appear and to appear prominently in the interactive map. In another example, the residence or location of adjacent users in the social network is inferred to indicate that the user submitting the request is interested in the residence or location of a friend, and this feature is lowered in rank, making the feature more likely to appear and to appear prominently.

In another example, rank is adjusted based on the search history of the user. For example, features within the map extent having a name appearing in the search history may be decreased in rank, or features may be decreased in rank in response to determining that the features have a name appearing in a website that the user clicked on in search results.

The prominence of a depiction of a feature is determined by a variety of attributes of the depiction, which may be selected individually or in combination. Examples of such attributes include the font, the font size, the font color, a drop shadow, transparency, a feature color, a feature transparency, depiction of the feature in 3-D (e.g. an isometric view), line weight, line color, and the like. In some embodiments, each feature rank corresponds to a different style of depicting that feature, and each style defines a group of visual formatting attributes applied as a group.

The process 36 further includes presenting the personalized map to the user, as indicated by block 46. In some embodiments, presenting the personalize map includes rendering images depicting the map or portions of the map based on results of step 44. In one example, only those features determined in step 44 to be low enough ranking to be depicted at a given zoom level are presented, and the prominence of those features is selected based on the prominence determined in step 44. The presented personalize map is received at the user device and displayed on a screen of the user device, for example in a browser window or in a special-purpose mapping application executing on the user device.

FIGS. 3 and 4 illustrate examples of interactive map websites 48 and 50, respectively. The map websites 48 and 50 each include a map 52 or 54, respectively, that is personalized based on a user profile of the user requesting the map 52 or 54. The maps 52 and 54, in this example, depict an identical map extent, but because the maps are personalized, the features presented and prominence of the features differs. For example, map 52 includes a road 56 that does not appear in map 54. The road 56 is depicted in response to the user for FIG. 3 having calendared an appointment at a doctor's office at feature 58, the appointment being on the day the user requested the map 52. Maps 52 and 54 both include feature 60 corresponding to Joe's pizza restaurant, but the feature 60 in map 52 has a higher prominence, with a larger font, in response to the user of FIG. 3 having reviewed restaurants in the cuisine category of pizza more favorably in the aggregate than the user of FIG. 4.

The map 52 further includes a drycleaners 62 and a gas station 64 in response to to the user of FIG. 3 having entered data into their user profile identifying their residence as being within the extent of map 52, causing features in categories more likely to be of interest to a resident to have an increased prominence and be more likely to be shown. In contrast, in this example, the user of FIG. 4 is viewing the map 54 from a location more than a threshold distance away from the area depicted in map 54 (e.g. more than 500 miles) and has a search history including searches for hotels in the area of map extent 54, indicating that the user of FIG. 4 likely intends to engage in tourism in the map extent. In response, map 54 includes tourist related features 66 that are not depicted in FIG. 3 because, while the default rank of these features 66 was decreased based on the profile of the user of FIG. 4, such a decrease was not applied for the user of FIG. 3. Map 54 further includes a feature 69 with an associated indicator 71 of the reason the feature 69 has a decreased rank, which in this case is because an adjacent nodes in the user's social graph gave the corresponding restaurant a favorable review (e.g., exceeding a threshold score, such as more than three out of five stars).

The interactive map websites 48 and 50 further include links 68 to other services, the use of which by the user updates the user's profile, and interfaces by which the user requests changes to the map 52 or 54, including a text search input box 70 for submitting queries, a panning tool 72 for requesting that the map be panned, and a zoom tool 74 for requesting a higher or lower zoom level.

As discussed above, some embodiments personalize maps based on user profiles. Personalizing maps reduces the burden on users otherwise viewing information likely to be of little interest to the user. And personalization highlights for the user features in which the user is likely to be interested, potentially alerting the user to areas of interest of which the user was not aware. Personalized maps improve the user experience relative to systems that present the same information to every user.

FIG. 5 is a diagram that illustrates an exemplary computing system 1000 in accordance with embodiments of the present technique. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030 and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an, ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area (WAN), a cellular communications network or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. Non-transitory computer readable storage medium may include, non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). In some embodiments, the program may be conveyed by a propagated signal, such as a carrier wave or digital signal conveying a stream of packets.

I/O interface 1050 may be configured to coordinate I/O traffic between processors 1010a-1010n, system memory 1020, network interface 1040, I/O devices 1060 and/or other peripheral devices. I/O interface 1050 may perform protocol, timing or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000, or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending or storing instructions or data implemented in accordance with the foregoing description upon a computer-accessible medium. Accordingly, the present invention may be practiced with other computer system configurations.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a”, “an” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Further, unless otherwise indicated, statements that one value or action is “based on” another condition or value encompass both instances in which the condition or value is the sole factor and instances in which the condition or value is one factor among a plurality of factors. Unless specifically stated otherwise, as apparent from the discussion, it is appreciated that throughout this specification discussions utilizing terms such as “processing”, “computing”, “calculating”, “determining” or the like refer to actions or processes of a specific apparatus, such as a special purpose computer or a similar special purpose electronic processing/computing device. In the context of this specification, a special purpose computer or a similar special purpose electronic processing or computing device is capable of manipulating or transforming signals, for instance signals represented as physical electronic, optical, or magnetic quantities within memories, registers, or other information storage devices, transmission devices, or display devices of the special purpose computer or similar special purpose processing or computing device.

What is claimed is:

1. A method of personalizing an interactive map, the method comprising:
receiving a user request to view an interactive map;
determining a map extent responsive to the request;
obtaining a profile of the user;
generating, with a computer, a personalized interactive map based on the profile by:
obtaining candidate features within a geographic extent specified by the user request from a geographic information system, the candidate features having a prominence ranking determined without regard to the user profile before receiving the user request;
adjusting the prominence ranking of some of the candidate features based on the user profile;
for each candidate feature, using the adjusted prominence ranking to determine whether to depict the respective candidate feature; and
for each depicted feature, using the adjusted prominence ranking to format the corresponding depiction; and
presenting the personalized map to the user.

2. The method of claim 1, wherein
using the adjusted prominence ranking to determine whether to depict the respective candidate feature comprises comparing the adjusted prominence ranking to a threshold prominence ranking; and
using the adjusted prominence ranking to format the corresponding depiction comprises selecting a style corresponding to the adjusted prominence ranking, the style being one of a plurality of candidate styles, each candidate style defining a font and a font size.

3. The method of claim 1, wherein adjusting the prominence ranking of some of the candidate features based on the user profile comprises:
determining that a feature has been shown to the user before in a previous interactive map session; and
in response to determining that a feature has been shown to the user before, adjusting the prominence ranking to make the feature less likely to be depicted and, if depicted, to be less prominent than the feature would appear absent determining that the feature has been shown to the user before.

4. The method of claim 3, wherein determining that the feature has been shown to the user before comprises determining that the features has been shown to the user more than a threshold number of times within a threshold amount of time in the past.

5. The method of claim 1, adjusting the prominence ranking of some of the candidate features based on the user profile comprises:
obtaining the location of the user;
determining a distance between the location of the user and a geographic location in the map extent; and
adjusting the prominence ranking based on the distance.

6. The method of claim 5, wherein adjusting the prominence ranking based on the distance comprises:
determining that the distance is greater than a threshold distance; and
in response to determining that the distance is greater than the threshold distance, decreasing the prominence ranking of a place in the map extent that is categorized as a place of interest to tourists.

7. The method of claim 1, wherein the profile comprises an identifier of an adjacent node of a user graph, and wherein adjusting the prominence ranking of some of the candidate features based on the user profile comprises:
identifying the adjacent node on the social graph;
identifying a second user profile associated with the adjacent node on the social graph; and
adjusting the prominence ranking based on information contained in the second user profile.

8. The method of claim 1, wherein the profile comprises a calendar of the user, and wherein adjusting the prominence ranking of some of the candidate features based on the user profile comprises:
identifying a feature associated with a calendar entry within a threshold time of the current time; and
decreasing the prominence ranking of the feature.

9. The method of claim 1, wherein:
the profile comprises a user rating of a businesses,
using the adjusted prominence ranking to determine whether to depict the respective candidate feature comprises determining to depict the business in the map responsive to determining that the corresponding user rating is greater than a rating threshold; and
using the adjusted prominence ranking to format the corresponding depiction comprises formatting the depiction of the business according to the rating by selecting a font, font size, font color, drop shadow, feature color, feature size, or a combination thereof for use in the depiction of the business.

10. The method of claim 1, wherein the user profile comprises a search history of the user, and wherein generating the personalized interactive map based on the profile comprises:
determining that a name of a geographic feature appears in the search history and, in response, increasing the prominence of the depiction relative to a prominence that the feature would receive absent determining that a name of a geographic feature appears in the search history.

11. The method of claim 1, wherein the user profile comprises a user preferences for a cuisine, and wherein generating the personalized interactive map based on the profile comprises formatting a restaurant serving the cuisine identified by the user preference to be depicted more prominently than the respective restaurants would appear absent the user preference.

12. The method of claim 1, further comprising:
receiving another request to view an interactive map from another user, the request and the other request both requesting the same map extent;
obtaining another profile of the other user;
generating another personalized interactive map based on other profile, wherein the geographic features depicted in the personalized map are different from the features depicted in the other personalized map, and wherein at least one feature depicted in the personalized map is depicted with different formatting in the other personalized map; and
presenting the other personalized map to the other user.

13. The method of claim 1, wherein:
the user profile is associated with profiles of other users through a social network, the profiles of other users comprising a rating or a review, and wherein generating the personalized interactive map based on the profile comprises formatting a feature based on the rating, review, or both.

14. The method of claim 1, wherein generating the personalized interactive map based on the profile comprises:
for at least some of the depicted features, depicting an explanation for a prominence of the feature based on the user profile.

15. The method of claim 1, wherein the user profile comprises information about the user from previous user interactions with a plurality of different sources, including at least three of the following: a social network, a search engine, user reviews, user place bookmarks on a map, user ratings, user preferences.

16. The method of claim 1, wherein the user profile comprises a location history of the user, and wherein personalizing the interactive map based on the profile comprises depicting a traffic layer in the map, the traffic layer depicting traffic on roads selected based on the location history.

17. The method of claim 1, wherein:
receiving a user request to view an interactive map comprises:
the user navigating to a map search engine website and entering a text query input into the map search engine website;
receiving the query; and
determining a map extent responsive to the query based on the text of the query;
obtaining the profile of the user comprises:
obtaining permission from the user to obtain the profile and use the profile;
logging user interactions with a search engine, the interactions including queries and user selections of search results;
receiving user expressions of interest in places through ratings by the user of respective places;
receiving user reviews of places;
receiving bookmarks of places on the interactive map by the user;
receiving identifications of profiles of friends of the user;
receiving user check-ins at geographic features;
receiving user preferences for events, food, and travel; and
receiving a location history of the user from mobile device of the user;
generating the personalized interactive map based on the profile comprises:
receiving from a geographic information system features within the determined map extent, the features including a feature name, a feature location, and a default prominence rank;
calculating a modified prominence rank by decreasing the default prominence rank in response to determining that the feature, as indicated by the user profile:
was the subject of a query in the logged user interactions with the search engine;
received an expression of interest from the user;
was the subject of a favorable review by the user;
is bookmarked by the user;
is hosting an event corresponding to a user preference for events;
serves a cuisine corresponding to a user preference for cuisine; and
is in a city corresponding to a user preference for travel; and
presenting the personalized map comprises:
sending to a web browser of the user device instructions that, when executed, cause the web browser to depict the personalized map.

18. The method of claim 1, comprising:
selecting an advertisement based on the user request; and
presenting the advertisement with the personalized map.

19. A system, comprising:
one or more processors; and
memory storing program code that when executed by the one or more processors causes the one or more processors to perform operations comprising:
receiving a user request to view an interactive map;
determining a map extent responsive to the request;
obtaining a profile of the user;
generating, with a computer, a personalized interactive map based on the profile by:
obtaining candidate features within a geographic extent specified by the user request from a geographic information system, the candidate features having a prominence ranking determined without regard to the user profile before receiving the user request;
adjusting the prominence ranking of some of the candidate features based on the user profile;
for each candidate feature, using the adjusted prominence ranking to determine whether to depict the respective candidate feature; and
for each depicted feature, using the adjusted prominence ranking to format the corresponding depiction; and
presenting the personalized map to the user.

20. A tangible, machine-readable medium storing instructions that when executed by a data processing apparatus causes the data processes apparatus to perform operations comprising:
receiving a user request to view an interactive map;
determining a map extent responsive to the request;
obtaining a profile of the user;
generating, with a computer, a personalized interactive map based on the profile by:
obtaining candidate features within a geographic extent specified by the user request from a geographic information system, the candidate features having a prominence ranking determined without regard to the user profile before receiving the user request;
adjusting the prominence ranking of some of the candidate features based on the user profile;
for each candidate feature, using the adjusted prominence ranking to determine whether to depict the respective candidate feature; and
for each depicted feature, using the adjusted prominence ranking to format the corresponding depiction; and
presenting the personalized map to the user.
